(19) United States
(12) Patent Application Publication
(10) Pub. No.: US 2015/0261494 A1
(43) Pub. Date: Sep. 17, 2015

(54) SYSTEMS AND METHODS FOR COMBINING SELECTION WITH TARGETED VOICE ACTIVATION

(71) Applicant: Google Inc., Mountain View, CA (US)

(72) Inventors: Gabriel Cohen, Alameda, CA (US); Alexander Faaborg, Mountain View, CA (US)

(73) Assignee: Google Inc., Mountain View, CA (US)

(21) Appl. No.: 14/213,515

(22) Filed: Mar. 14, 2014

(51) Int. Cl. G06F 3/16; G06F 3/0488

(52) U.S. Cl. CPC G06F 3/167; G06F 3/0488

(57) ABSTRACT

In an example implementation of the disclosed technology, a method may include outputting, for display, an object and receiving an indication of an input gesture entered at a presence-sensitive input device to select the object and activate an audio input device. The method may also include, responsive to receiving the indication of the input gesture, activating the audio input device. The method may also include receiving an indication of an audio command received by the audio input device, the audio command to perform an action on the object. The method may also include, responsive to receiving the indication of the audio command, performing the action on the object indicated by the audio command.

### BACKGROUND

Computing devices may perform certain functions in response to audio commands such as voice commands. In order to use audio commands to initiate a function to be performed on an object such as a displayed item associated with an application, an audio input device such as a microphone may be kept in a constant, active listening state until an audio command is received. Alternatively, a user may be required to perform a first action to select the object and then a separate, second action to activate the audio input device prior to entering an audio command. Maintaining the audio input device in a constant listening state may impose a significant drain on battery power, however, and requiring a second action to activate the audio input device may distract focus of the user away from the object and associated tasks at hand.

### SUMMARY

Some or all of the above needs may be addressed by certain implementations of the disclosed technology. Certain implementations may include methods, systems, and non-transitory computer-readable medium for, in response to receiving a predetermined input gesture to select an object and activate an audio input device, selecting the object and activating the audio input device to receive an audio command to perform an action on the object and, in response to receiving the audio command, performing the action on the object.

According to an example implementation, a method is provided. The method may include outputting, by a computing device, for display, an object, and receiving, by the computing device, an indication of an input gesture entered at a presence-sensitive input device to select the object and activate an audio input device. The method may also include, responsive to receiving the indication of the input gesture, activating, by the computing device, the audio input device. The method may also include receiving, by the computing device, an indication of an audio command received by the audio input device, the audio command to perform an action on the object. The method may also include, responsive to receiving the indication of the audio command, performing, by the computing device, the action on the object.

According to another example implementation, a system is provided. The system includes one or more processors and a memory coupled to the one or more processors. The memory may store instructions that, when executed by the one or more processors, cause the system to perform functions that may include outputting, for display, an object. The functions may also include receiving an indication of a predetermined input gesture entered at a presence-sensitive input device to select the object and activate an audio input device. The functions may also include, responsive to receiving the indication of the predetermined input gesture, activating the audio input device. The functions may also include receiving an indication of an audio command received by the audio input device, the audio command to perform an action on the object. The functions may also include, responsive to receiving the indication of the audio command, performing an action on the object indicated by the audio command.

According to another example implementation, a non-transitory computer-readable medium is provided. The computer-readable medium may store instructions that, when executed by one or more processors, cause a computing device to perform functions that may include outputting, for display, an object. The functions may also include receiving an indication of a predetermined input gesture entered at a presence-sensitive input device to select the object and activate an audio input device. The functions may also include, responsive to receiving the indication of the predetermined input gesture, activating the audio input device. The functions may also include receiving an indication of an audio command received by the audio input device, the audio command to perform an action on the object. The functions may also include, responsive to receiving the indication of the audio command, performing an action on the object indicated by the audio command.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative computer system architecture 100, according to an example implementation.

FIG. 2A illustrates a computing device 200 with an object that is output for display, according to an example implementation.

FIG. 2B illustrates the computing device 200 with a selected object and visual indicators that are output for display, according to an example implementation.

FIG. 2C illustrates user interaction with the computing device 200 to enter an audio command, according to an example implementation.

FIG. 2D illustrates the computing device 200 with a manipulated object that is output for display, according to an example implementation.

FIG. 3A illustrates a computing device 300 with an object that is output for display, according to an example implementation.

FIG. 3B illustrates the computing device 300 with a selected object and visual indicators that are output for display, according to an example implementation.

FIG. 3C illustrates user interaction with the computing device 300 to enter an audio command, according to an example implementation.

FIG. 3D illustrates the computing device 300 with a manipulated object that is output for display, according to an example implementation

FIG. 4A illustrates a computing device 400 with an object that is output for display, according to an example implementation.

FIG. 4B illustrates the computing device 400 with a selected object and visual indicators that are output for display, according to an example implementation.

FIG. 4C illustrates user interaction with the computing device 400 to enter an audio command, according to an example implementation.

FIG. 4D illustrates the computing device 400 with a manipulated object that is output for display, according to an example implementation.

FIG. 5 is a flow diagram of a method 500 according to an example implementation.

### DETAILED DESCRIPTION

In certain implementations of the disclosed technology, a computing device, in response to receiving a predetermined input gesture to select an object and activate an audio input device, selects the object and activates the audio input device to receive an audio command to perform an action on the object and, in response to receiving the audio command, performs the action on the object.

In an example implementation, a computing device receives an indication of an input gesture to select an object that is currently output for display and, in response, activate an audio input device to receive an audio command. In some implementations, the audio input device may be a microphone operatively coupled to or included in the computing device. Responsive to receiving an audio command to perform an action on the object, the computing device performs the action on the object. The computing device may output, for display, the object at a first location of a display device, wherein the first location of the display device corresponds to a first location of an input device where the input gesture is entered. This first location of the input device may be, for example a particular location of a presence-sensitive input device (such as a touchscreen) operatively coupled to or included in the computing device. The audio command may include one or more voice commands to perform the action on the object.

In some implementations, the object may be associated with functions of an application executable on the computing device and/or operating system functions, and the computing device may determine a context for the desired action based on an association of the voice command, object, and application and/or operating system. The context may be determined based on one or more particular applications executing on the computing device at the time the object is selected and/or based on an association of functions relating to the object within the one or more applications. Based on the determined context, the computing device may determine what actions are available to be performed on the object (e.g., which functions can be performed with respect to the object using the particular applications. In some implementations, The computing device may output, for display, visual indications to identify audio commands that, when entered via the audio input device, can cause the computing device to perform one or more of the available actions.

In an example implementation, the input gesture includes a touch gesture by one or more input objects, such as a stylus or one or more fingers placed at a presence-sensitive input device of the computing device. The input gesture may correspond to a plurality of input objects being placed simultaneously at a particular location of the presence-sensitive device that is associated with the object to be acted upon, for example a plurality of stylus, fingertips, or fingernails being placed adjacent to one another at a location proximate the object as displayed. The input gesture may alternatively correspond to a plurality of input objects being placed, one at a time in a sequential, progressive fashion at a location proximate the object as displayed. The input gesture may require that the input objects be held at the particular location of the presence-sensitive input device for a predetermined period of time before the computing device will activate the audio input device in response. In another example implementation, the input gesture corresponds to an input object being moved according to a pattern that resembles a circle, square, triangle, or other shape to define a virtual perimeter that surrounds the object as displayed. For example, an input object such as a finger or stylus may move about an area of the presence-sensitive input device that corresponds to the location of the display device where the object is displayed.

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Example implementations of the disclosed technology will now be described with reference to the accompanying figures.

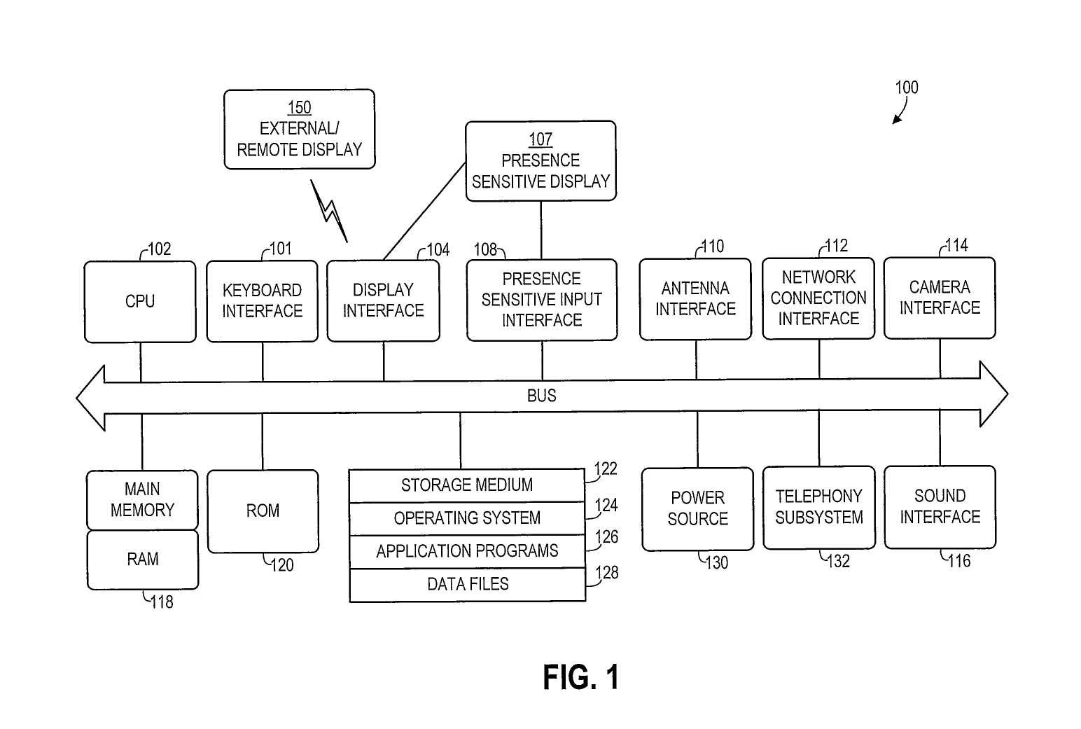

As desired, implementations of the disclosed technology may include a computing device with more or less of the components illustrated in FIG. 1. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that acts as a communication interface and provides functions for rendering video, graphics, images, and texts on the display. In certain example implementations of the disclosed technology, the display interface 104 may be directly connected to a local display, such as a touch-screen display associated with a mobile computing device. In another example implementation, the display interface 104 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 104 may wirelessly communicate, for example, via a Wi-Fi channel or other available network connection interface 112 to the external/remote display.

In an example implementation, the network connection interface 112 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 104 may be operatively coupled to a local display, such as a touch-screen display associated with a mobile device. In another example, the display interface 104 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 104 may wirelessly communicate, for example, via the network connection interface 112 such as a Wi-Fi transceiver to the external/remote display.

The computing device architecture 100 may include a keyboard interface 106 that provides a communication interface to a keyboard. In one example implementation, the computing device architecture 100 may include a presence-sensitive display interface 108 for connecting to a presence-sensitive display 107. According to certain example implementations of the disclosed technology, the presence-sensitive display interface 108 may provide a communication interface to various devices such as a pointing device, a touch screen, a depth camera, etc. which may or may not be associated with a display.

The computing device architecture 100 may be configured to use an input device via one or more of input/output interfaces (for example, the keyboard interface 106, the display interface 104, the presence sensitive display interface 108, network connection interface 112, camera interface 114, sound interface 116, etc.,) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example implementations of the computing device architecture 100 may include an antenna interface 110 that provides a communication interface to an antenna; a network connection interface 112 that provides a communication interface to a network. As mentioned above, the display interface 104 may be in communication with the network connection interface 112, for example, to provide information for display on a remote display that is not directly connected or attached to the system. In certain implementations, a camera interface 114 is provided that acts as a communication interface and provides functions for capturing digital images from a camera. In certain implementations, a sound interface 116 is provided as a communication interface for converting sound into electrical signals using a microphone and for converting electrical signals into sound using a speaker. According to example implementations, a random access memory (RAM) 118 is provided, where computer instructions and data may be stored in a volatile memory device for processing by the CPU 102.

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example implementation, the computing device architecture 100 includes a power source 130 that provides an appropriate alternating current (AC) or direct current (DC) to power components. According to an example implementation, the computing device architecture 100 includes and a telephony subsystem 132 that allows the device 100 to transmit and receive sound over a telephone network. The constituent devices and the CPU 102 communicate with each other over a bus 134.

According to an example implementation, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 128 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example implementation, the term computing device, as used herein, may be a CPU, or conceptualized as a CPU (for example, the CPU 102 of FIG. 1). In this example implementation, the computing device (CPU) may be coupled, connected, and/or in communication with one or more peripheral devices, such as display. In another example implementation, the term computing device, as used herein, may refer to a mobile computing device such as a smartphone or tablet computer. In this example embodiment, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

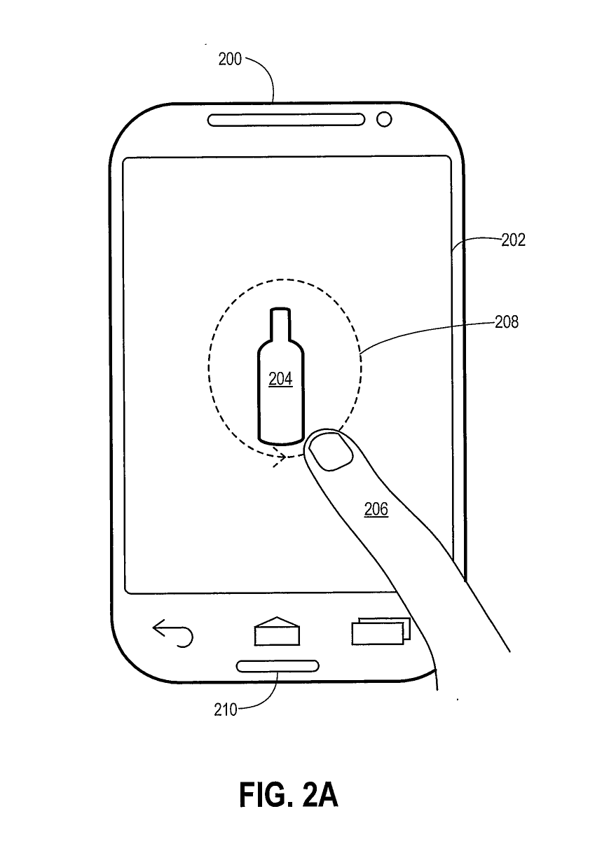

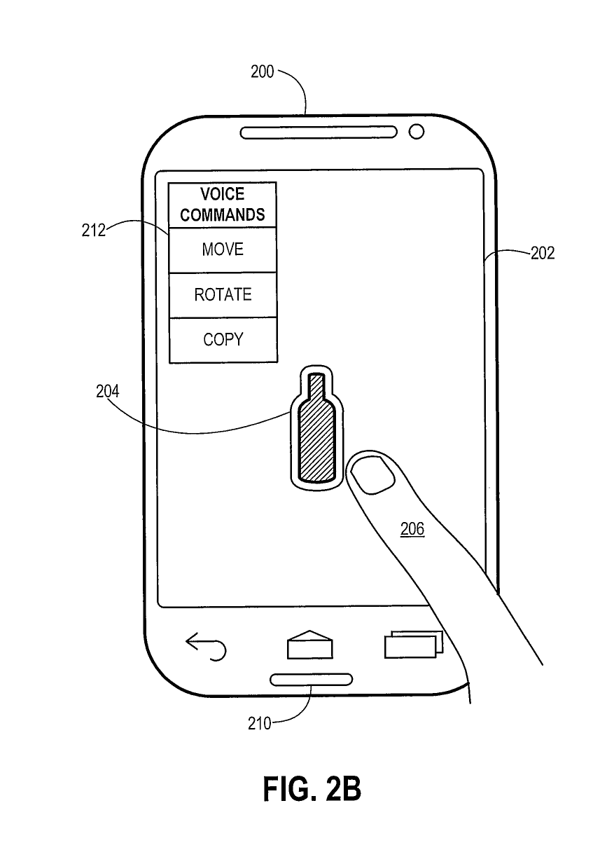

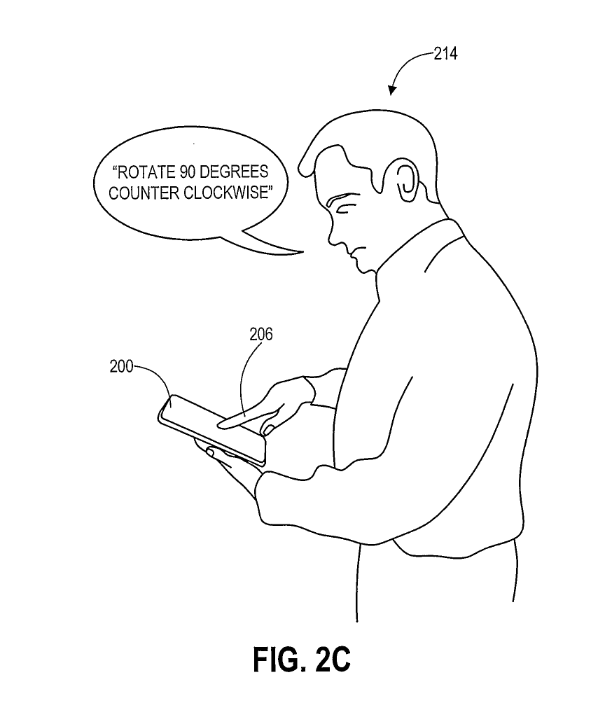

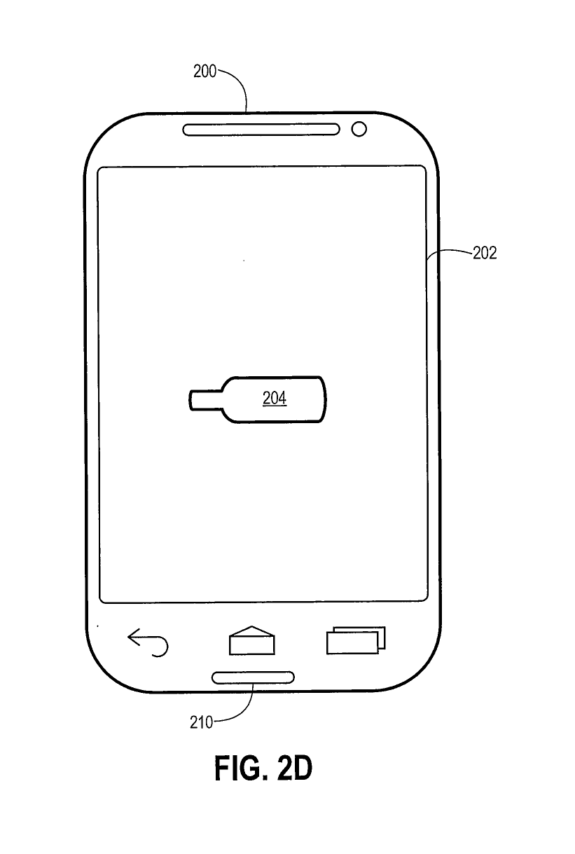

FIG. 2A illustrates a mobile computing device 200 according to an example implementation of the disclosed technology, which may include some or all of the components of the computing device 100 shown in FIG. 1. The computing device 200 is configured to output an object 204 for display on a display screen 202. The object 204 is a shape associated with an application running on the computing device 200 that has functionality to manipulate the position, orientation, and and/or other characteristics of the object 204. The application may be, for example, a design application, presentation application, or artwork application. In the example implementation shown, the display screen 202 is a presence-sensitive input device, and in particular a touchscreen, that is configured to, in response to detecting a gesture from an input object 206, provide an indication to the computing device 200 that an input gesture has been entered and to indicate the nature of the gesture and/or manner in which the gesture is entered.

An input object 206, and in particular, as shown, a finger, enters a gesture with respect to the displayed object 204, wherein the finger is placed on or proximate a surface of the display screen 202 and moves in a circular motion illustrated by a dashed arrow 208 to define a perimeter around the object 204 such that the object 204 is substantially encircled. The motion of the gesture may alternatively correspond to outlining another type of enclosing shape such as a triangle or square to substantially surround the object 204. The gesture may require that the input object 206 be held at a final position of the gesture for a predetermined amount of time. The gesture represents an intent of a user of the computing device to select the object 204 and also to activate an audio input device 210 of the computing device, such as a microphone, for receiving audio commands.

In response receiving an indication of the gesture, the computing device 200 causes the object 204 to be selected, as indicated by visual emphasis on the object 204 as displayed, in the form of a color inversion as shown in FIG. 2B. Those of ordinary skill will recognize that selection of an object may be shown in numerous additional or alternative ways, for example other forms of visual emphasis on the object 204. Also in response to the gesture, the computing device 200 activates the audio input device 210 for receiving an audio command to perform an action on the object 204. The computing device 200 may determine a context for a desired action to be performed on the object 204 based on an association of the object 204 and one or more applications executing on the computing device 200. The context may be determined based on the particular applications executing on the computing device 200 at the time the object 204 is selected and/or based on an association of functions relating to the object 204 within the one or more applications. Based on the determined context, the computing device 200 may determine what actions are available to be performed on the object 204, such as what functions can be performed through the particular applications with respect to the object 204. For example, where the object 204 is associated with a design, presentation, or art application, the available functions supported by the application may include manipulating the position, orientation, and/or other visual characteristics of the object 204.

The computing device 200 may output, for display on the display screen 202, visual indicators (see FIG. 2B) to identify available audio commands that are supported by the one or more applications executing on the computing device 200 at the time the input gesture is entered. The supported audio commands are commands that, when entered via the audio input device 210, cause the computing device 200 to perform one or more of the available actions, for example through functionalities provided by the executing applications. As shown in FIG. 2B, next to the selected object 204, the computing device 200 has output, for display on the display screen 202, a list 212 of available commands for user reference, and in particular available voice commands to “move” the object 204 to a different position or location, “rotate” the object 204 into a different orientation, or “copy”, that is, duplicate the object 204. It should be appreciated that the visual indicators 212 that may be displayed are not limited to the specific commands shown or their various corresponding functions. The visual indicators 212 are further not limited to a certain number or type of supported commands or various corresponding functions and are not limited to the specific commands shown. The supported commands to be displayed may be determined based on factors such as commands that have been used most frequently or most recently. As shown in FIG. 2C, while maintaining the input object 206 at the location of the display 202 corresponding to the end of the circling gesture shown in FIG. 2A, a user 214 of the computing device 200 voices a command to rotate the object 204 (“Rotate 90 degrees counterclockwise.”).

In response, as shown in FIG. 2D, the computing device 200 causes the application to rotate the object 204, and the computing device 200 outputs, for display, the object 204 as repositioned according to the command. In particular, the object 204 is displayed in FIG. 2D in an orientation that is 90 degrees counterclockwise relative to the initial orientation of the object 204 shown in FIG. 2A. In the illustration of FIG. 2D, the input object 206 previously shown in FIGS. 2A-2C is not present, as it has been released upon or after entering the voice command. In an alternative implementation, the user 212 may not be required to maintain the input object 206 at the touchscreen 202 when entering a voice command.

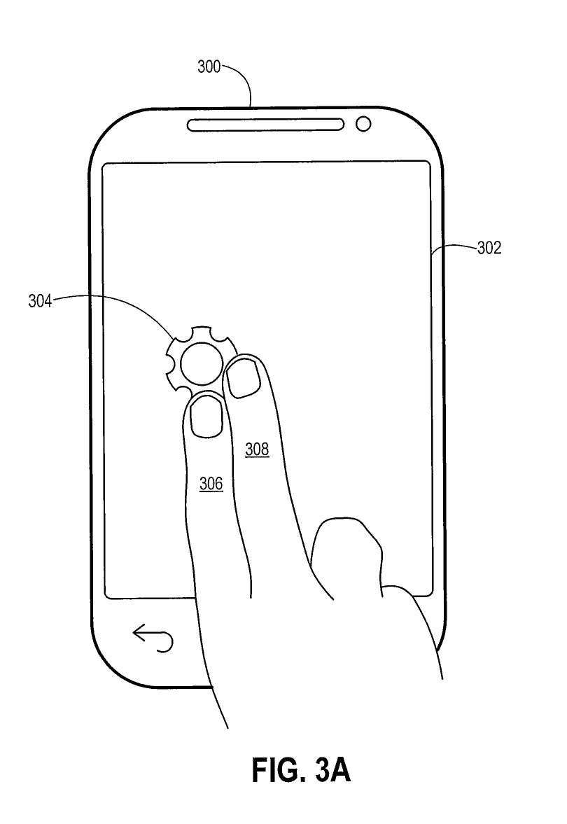

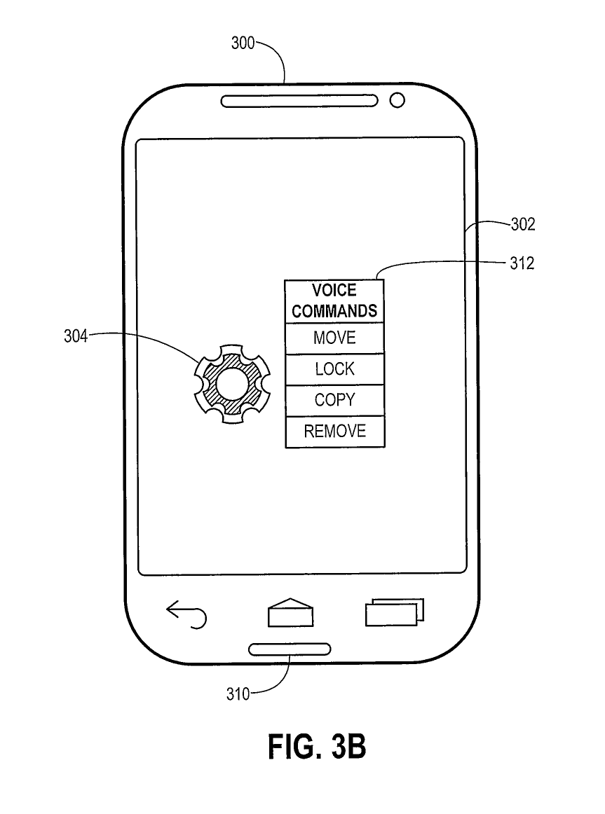

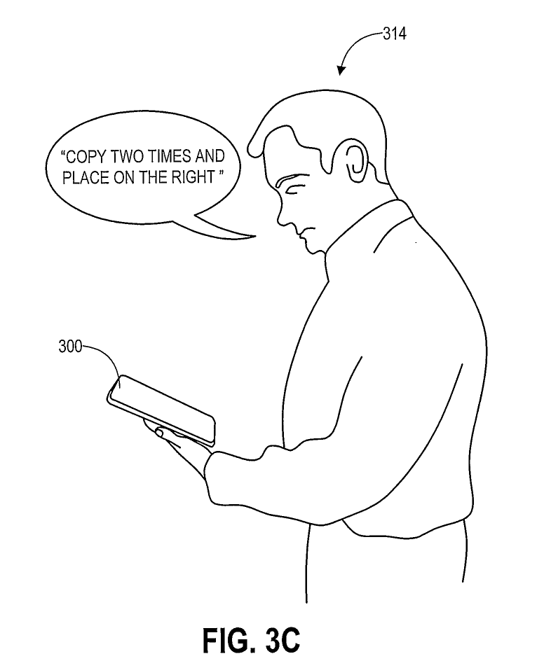

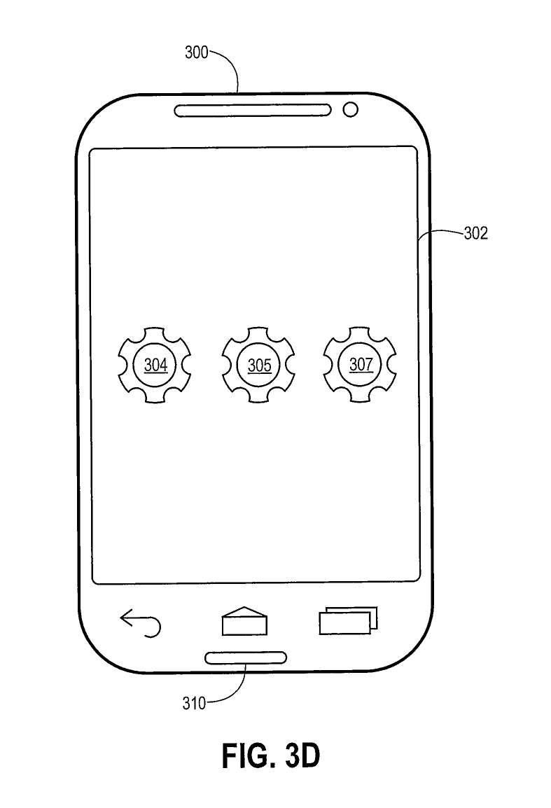

FIG. 3A illustrates a mobile computing device 300 according to an example implementation of the disclosed technology, which may include some or all of the components of the computing device 100 shown in FIG. 1. The computing device 300 is configured to output, for display on a display screen 302, an object 304. As shown, the object 304 is a shape associated with an application running on the computing device 300 that has functionality to manipulate the position, orientation, or other characteristics of the object 304 and/or to duplicate the object 304. The application may be, for example, a design application, presentation application, or artwork application. In the example implementation shown, the display screen 302 is configured as a presence-sensitive input device, and in particular a touchscreen, that is configured to, in response to detecting a gesture from input objects 306, 308, provide an indication to the computing device 300 that an input gesture has been entered and an indication of the nature of the gesture and/or manner in which the gesture is entered.

Input objects 306, 308 and in particular, as shown, two adjacent fingers that are placed in parallel to one another on or proximate a surface of the display screen 302, are used to enter a gesture with respect to the displayed object 304. The fingers may be placed simultaneously, or alternatively they may be placed in a progressive, successive fashion such that one finger (306) is placed first and the adjacent, other finger (308) is placed afterwards. The gesture may require that the input objects 306, 308 be held at a final position of the gesture for a predetermined amount of time. The gesture represents an intent by a user of the computing device 300 (see FIG. 3C) to select the object 304 and also to activate an audio input device 310 of the computing device 300, which may be a microphone, for receiving audio commands.

In response to the gesture to select the object 304, the computing device 300 causes the object 304 to be selected, as indicated by visual emphasis on the object 304 as displayed, in the form of a color inversion as shown in FIG. 3B. Those of ordinary skill will recognize that selection of an object can be shown in numerous additional or alternative ways, for example other forms of visual emphasis on the object 304. Also in response to the gesture, the computing device 300 activates the audio input device 310 for receiving an audio command to perform an action on the object 304. The computing device 300 may determine a context for a desired action to be performed on the object 304 based on an association of the object 304 and one or more applications executing on the computing device 300. The context may be determined based on the particular applications executing on the computing device 300 at the time the object 304 is selected and/or based on an association of functions relating to the object 304 within the one or more applications. Based on the determined context, the computing device 300 may determine what actions are available to be performed on the object 304, such as what functions can be performed through the particular applications with respect to the object 304. For example, where the object 304 is associated with a design, presentation, or art application, the available functions supported by the application may include manipulating the position, orientation, or other characteristics of the object 304 and/or duplicating the object 304.

The computing device 300 may output, for display on the display screen 302, visual indicators (see FIG. 3B) to identify available audio commands that are supported by the one or more applications executing on the computing device 300 at the time the input gesture is entered, where the supported audio commands are commands that, when entered via the audio input device 310, cause the computing device 300 to perform one or more of the available actions with respect to the object 304, for example through functionalities provided by the executing applications. As shown in FIG. 3B, next to the selected object 304, the computing device 300 has output, for display on the display screen 302, a list 312 of available commands for user reference, and in particular available voice commands to “move” the object 304 to a different position or location, “lock” the position or location of the object 304, “copy”, that is, make a duplicate of the object 304, or “remove” the object 304. It should be appreciated that the visual indicators 312 that may be displayed are not limited to the specific commands shown or their various corresponding functions. The visual indicators 312 are further not limited to a certain number or type of supported commands or various corresponding functions and are not limited to the specific commands shown. The supported commands to be displayed may be determined based on factors such as commands that have been used most frequently or most recently. As shown in FIG. 3C, a user 314 of the computing device 300 voices a command to duplicate the object 304 and place two duplicates 305, 307 to the right of the object 304 (“Copy two times and place on the right.”).

In response, as shown in FIG. 3D, the computing device 300 causes the application to produce two copies (305, 307) of the object 304 and outputs, for display, the copies 305, 307 adjacent and to the right of the object 304, in accordance with the command. In the example implantation illustrated in FIGS. 3C and 3D, the input objects 306, 308 previously shown in FIGS. 3A and 3B are not present, as they have been removed from the display screen 302 upon or after the object 304 is selected and prior to entering the voice command.

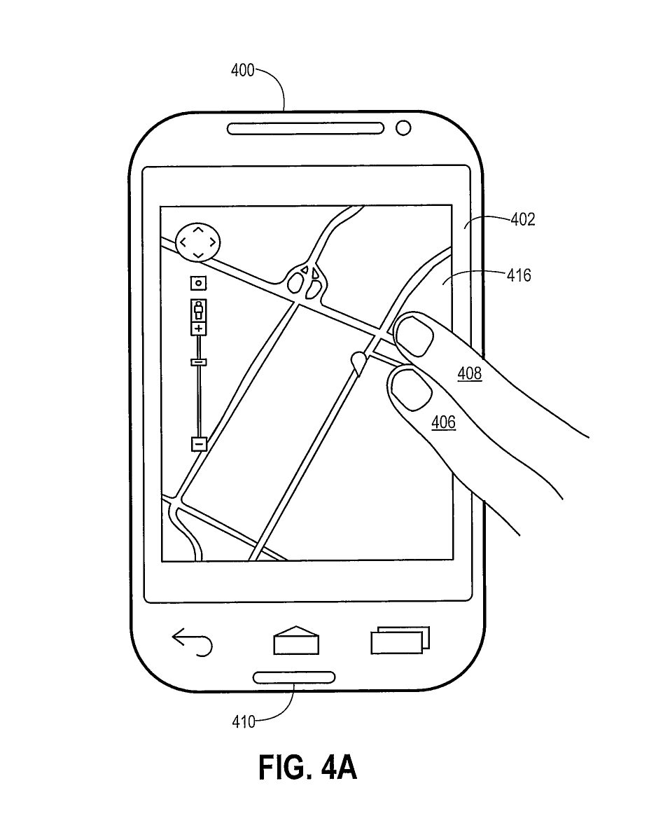

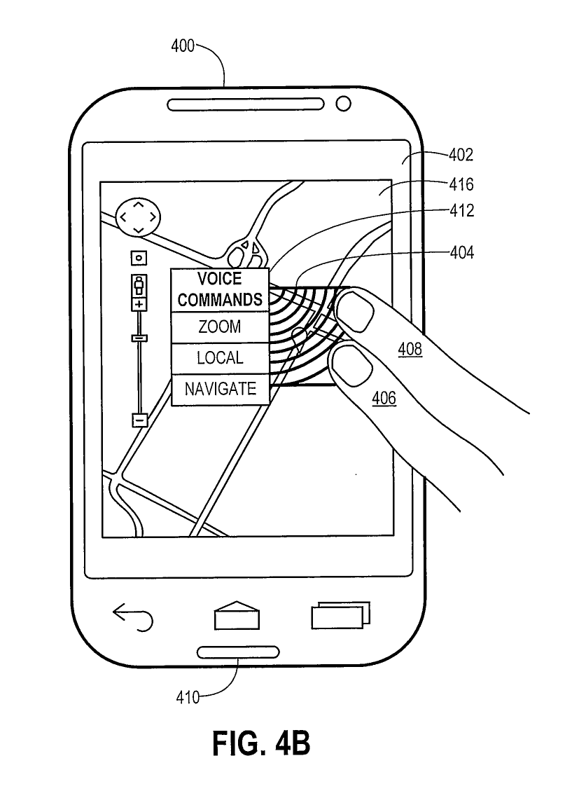

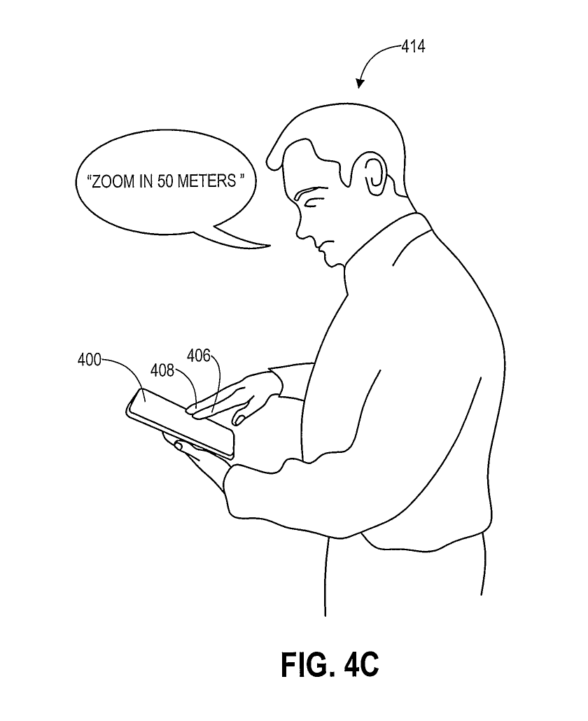

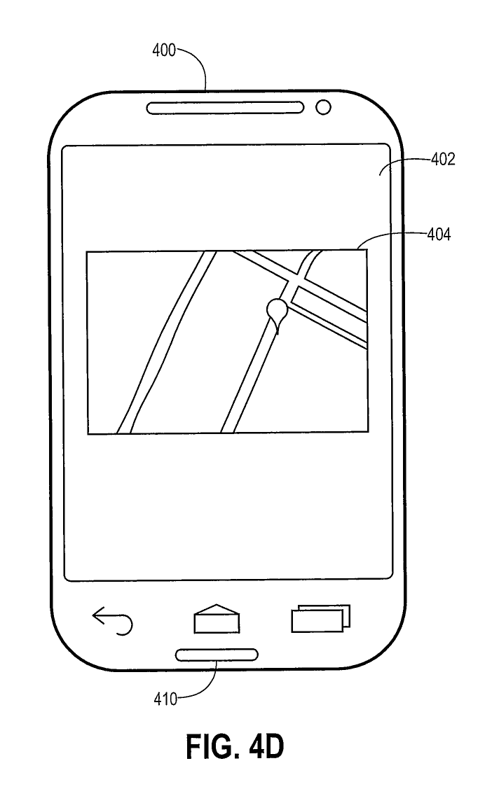

FIG. 4A illustrates a mobile computing device 400 according to an example implementation of the disclosed technology, which may include some or all of the components of the computing device 100 shown in FIG. 1. The computing device 400 is configured to output, for display on a display screen 402, a map view 416 that includes a particular object 404, which, in this example implementation, corresponds to a geographic area of interest. As shown in FIG. 4B, the object 404 is particular region of mapped territory shown within the map view 416 produced by a map application such as a web-based and/or geolocation-based plotting, location searching, and/or navigation application running on the computing device 400, where the application has functionality to display zoomed-in or zoomed-out views of a particular geographic area, search for and locate local, particular items of interest, and/or navigate to particular locations associated with an area of interest. In the example implementation shown, the display screen 402 is configured as a presence-sensitive input device, and in particular a touchscreen, that is configured to, in response to detecting a gesture from input objects 406, 408 provide an indication to the computing device 400 that an input gesture has been entered and indicate the nature of the gesture and/or manner in which the gesture is entered.

Input objects 406, 408, and in particular, as shown, two adjacent fingers that are placed in parallel to one another on or proximate a surface of the display screen 402, are used to enter a gesture with respect to the displayed object 404. The fingers may both be placed simultaneously, or alternatively they may be placed in a progressive, successive fashion such that one finger (406) is placed first and the adjacent, other finger (408) is placed afterwards. The gesture may require that the input objects 406, 408 be held at a final position of the gesture for a predetermined amount of time. The gesture represents an intent by a user of the computing device 400 (see FIG. 4C) to select the object 404 and also to activate an audio input device 410 of the computing device 400, such as a microphone, for receiving audio commands.

In response to the gesture to select the object 404, the computing device 400 causes the object 404 to be selected, as indicated by visual emphasis on the object 404 as displayed, in the form of a substantially rectangular, stripe-filled region as shown in FIG. 4B. Those of ordinary skill will recognize that selection of an object can be shown in numerous additional or alternative ways, for example other forms of visual emphasis. Also in response to the gesture, the audio input device 410 is activated for receiving an audio command to perform an action on the area of interest 404. The computing device 400 may determine a context for a desired action to be performed on the object 404 based on an association of the object 404 and one or more applications executing on the computing device 400.

The context may be determined based on the particular applications executing on the computing device 400 at the time the object 404 is selected and/or based on an association of functions relating to the object 404 within the one or more applications. Based on the determined context, the computing device 400 may determine what actions are available to be performed on the object 404, such as what functions can be performed through the particular applications with respect to the object 404. For example, where the object 404 is associated with a map application, the available functions supported by the application may include displaying enlarged views or reduced views (e.g. zoomed-in or zoomed-out views) of a particular geographic area, search and locate local, particular items of interest, and/or navigate to particular locations associated with an area of interest.

The computing device 400 may output, for display on the display screen 402, visual indicators (see FIG. 4B) to identify available audio commands that are supported by the one or more applications executing on the computing device 400 at the time the input gesture is entered, where the supported audio commands are commands that, when entered via the audio input device 410, cause the computing device 400 to perform one or more of the available actions with respect to the object 404, for example through functionalities provided by the executing applications. As shown in FIG. 4B, next to the selected object 404, the computing device 400 has output, for display on the display screen 402, a list 412 of available commands for user reference, and in particular available voice commands to “zoom” in or out to display enlarged views or reduced views associated with the object 404, search for and locate “local,” particular items of interest, or “navigate” to particular locations associated with the object 404. It should be appreciated that the visual indicators 412 that may be displayed are not limited to the specific commands shown or their various corresponding functions. The visual indicators 412 are further not limited to a certain number or type of supported commands or various corresponding functions and are not limited to the specific commands shown. The supported commands to be displayed may be determined based on factors such as commands that have been used most frequently or most recently. As shown in FIG. 4C, while maintaining the input objects 406, 408 at display screen 402, a user 414 of the computing device 400 voices a command to enlarge the view of the selected object 404, i.e. the area of interest (“Zoom in 50 meters.”). In response, as shown in FIG. 4D, the computing device 400 causes the application to display a zoomed-in view of the object 404 in accordance with the command.

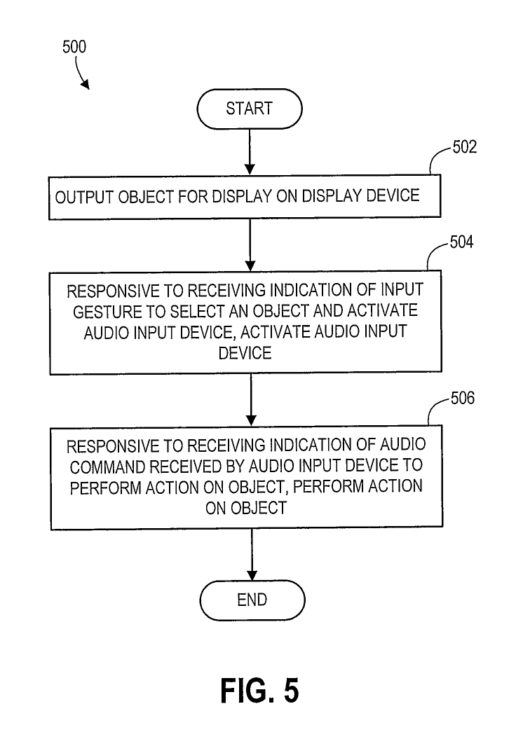

FIG. 5 is a flow diagram of a method 500 according to an example implementation of the disclosed technology. The method 500 begins at block 502, where a computing device outputs, for display, an object. At block 504, in response to receiving, at the computing device, an indication of a predetermined input gesture at a presence-sensitive input device to select the object and also activate an audio input device, the computing device activates the audio input device. At block 506, in response to receiving an indication of an audio command received by the audio input device to perform an action on the object, the computing device performs the action on the object. The method 500 ends following block 506.

Outputting the object for display may include outputting, by the computing device, for display, the object at a first location of a display device, wherein the indication of the predetermined input gesture at the presence-sensitive input device corresponds to an input gesture entered at a location of the presence-sensitive input device that corresponds to the first location of the display device. In an example implementation, the computing device determines, based on a contextual association of the object with at least one application executing on the computing device, an available action to perform on the object and outputs, for display on the display device, a visual indicator to identify an audio command that, when entered by way of the audio input device, causes the computing device to perform the available action on the object.

In an example implementation, the input gesture corresponds to a press-and-hold gesture wherein a plurality of input objects are simultaneously and adjacently positioned proximate the location of the presence-sensitive input device that corresponds to the first location of the display device. In another example implementation, the input gesture corresponds to an input object moving such as to define a pattern substantially enclosing the object as displayed. In still another example implementation, the input gesture corresponds to a gesture wherein a plurality of input objects are progressively placed proximate the location of the presence-sensitive input device that corresponds to the first location of the display device.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
outputting, by a computing device, an object for display at a first location of a display device;
receiving, by the computing device, an indication of a predetermined input gesture entered at a first location of a presence-sensitive input device corresponding to the first location of the display device, the predetermined input gesture configured to (i) select the object and (ii) activate an audio input device to receive an audio command to perform an action associated with the object, the predetermined input gesture comprising a hold gesture that is held for at least a predetermined amount of time;
responsive to receiving the indication of the predetermined input gesture and determining that the hold gesture is held for at least the predetermined amount of time, selecting the object and activating, by the computing device, the audio input device to receive an audio command to perform an action on the object;
receiving, by the computing device, an indication of a first predetermined audio command, received by the audio input device, to perform a first predetermined action on the object; and
responsive to receiving the indication of the first predetermined audio command, performing, by the computing device, the first predetermined action on the object.

2. (canceled)

3. The method of claim 1, further comprising:
determining, by the computing device, based on a contextual association of the object with at least one application executing on the computing device, an available action to perform on the object; and
outputting, by the computing device, for display on the display device, a visual indicator identifying an audio command that causes the computing device to perform the available action on the object.

4. The method of claim 1, wherein the predetermined input gesture comprises a gesture wherein a plurality of input objects are simultaneously and adjacently positioned proximate the first location of the presence-sensitive input device that corresponds to the first location of the display device.

5. The method of claim 4, wherein the predetermined input gesture comprises a press-and-hold gesture.

6. The method of claim 1, wherein the predetermined input gesture comprises a gesture wherein an input object moves such as to define a pattern substantially enclosing the object as displayed.

7. The method of claim 1, wherein the predetermined input gesture comprises a gesture wherein a plurality of input objects are progressively placed proximate the first location of the presence-sensitive input device that corresponds to the first location of the display device.

8. A system, comprising:
one or more processors;
a memory coupled to the one or more processors and storing instructions that, when executed by the one or more processors, cause the system to:
output, for display, an object at a first location of a display device;
receive an indication of a predetermined input gesture entered at a first location of a presence-sensitive input device corresponding to the first location of the display device, the predetermined input gesture configured to cause the system to (i) select the object and (ii) activate an audio input device to receive an audio command to perform an action associated with the object, the predetermined gesture comprising a hold gesture that is held for at least a predetermined amount of time;
responsive to receiving the indication of the predetermined input gesture and determining that the hold gesture is held for at least the predetermined amount of time, selecting the object and activating the audio input device to receive an audio command to perform an action associated with the object;
receive an indication of a first predetermined audio command received by the audio input device to perform a first predetermined action associated with the object; and
responsive to receiving the indication of the first predetermined audio command, perform the first predetermined action associated with the object.

9. (canceled)

10. The system of claim 8, further comprising:
determining, based on a contextual association of the object with at least one application executing in association with the system, an available action to perform on the object; and
outputting, for display on the display device, a visual indicator identifying an audio command that causes the system to perform the available action on the object.

11. The system of claim 8, wherein the predetermined input gesture comprises a gesture wherein a plurality of input objects are simultaneously and adjacently positioned proximate the first location of the presence-sensitive input device that corresponds to the first location of the display device.

12. The system of claim 11, wherein the predetermined input gesture comprises a press-and-hold gesture.

13. The system of claim 8, wherein the predetermined input gesture comprises a gesture wherein an input object moves such as to define a pattern substantially enclosing the object as displayed.

14. The system of claim 8, wherein the predetermined input gesture comprises a gesture wherein a plurality of input objects are progressively placed proximate the first location of the presence-sensitive input device that corresponds to the first location of the display device.

15. A non-transitory computer-readable medium storing instructions that, when executed by one or more processors, cause a computing device to:
output an object for display at a first location of a display device;
receive an indication of a predetermined input gesture entered at a first location of the presence-sensitive input device corresponding to the first location of the display device, the predetermined input gesture configured to (i) select the object and (ii) activate an audio input device to receive an audio command to perform an action associated with the object, the predetermined input gesture comprising a hold gesture that is held for at least a predetermined period of time;
responsive to receiving the indication of the predetermined input gesture and determining that the hold gesture is held for at least the predetermined amount of time, activate the audio input device to receive an audio command to perform an action associated with the object;
receive an indication of a first predetermined audio command received by the audio input device to perform a first predetermined action associated with the object; and
responsive to receiving the indication of the first predetermined audio command, perform the first predetermined action associated with the object.

16. (canceled)

17. The non-transitory computer-readable medium of claim 15, wherein the instructions, when executed by the one or more processors, further cause the computing device to:
determine, based on a contextual association of the object with at least one application executing on the computing device, an available action to perform on the object; and
output, for display on the display device, a visual indicator identifying an audio command that causes the computing device to perform the available action on the object.

18. The non-transitory computer-readable medium of claim 15, wherein the predetermined input gesture comprises a gesture wherein a plurality of input objects are simultaneously and adjacently positioned proximate the first location of the presence-sensitive input device that corresponds to the first location of the display device.

19. The non-transitory computer-readable medium of claim 18, wherein the predetermined input gesture comprises a press-and-hold gesture.

20. The non-transitory computer-readable medium of claim 15, wherein the predetermined input gesture comprises a gesture wherein an input object moves such as to define a pattern substantially enclosing the object as displayed.

21. The non-transitory computer-readable medium claim 15, wherein the predetermined input gesture comprises a gesture wherein a plurality of input objects are progressively placed proximate the first location of the presence-sensitive input device that corresponds to the first location of the display device.
